(19) United States
(12) Patent Application Publication
(10) Pub. No.: US 2012/0320153 A1
(43) Pub. Date: Dec. 20, 2012

(54) DISPARITY ESTIMATION FOR STEREOSCOPIC SUBTITLING

(76) Inventors: Jesus Barcons-Palau, Burbank, CA (US); Joan Llach, Cesson Sevigne (FR)

(21) Appl. No.: 13/580,757

(22) PCT Filed: Dec. 20, 2010
(86) PCT No.: PCT/US10/03217

§ 371 Date: Aug. 23, 2012

Related U.S. Application Data
(60) Provisional application No. 61/308,174, filed on Feb. 25, 2010.

(51) Int. Cl. H04N 13/00

(52) U.S. Cl. 348/42; 348/E13.001

(57) ABSTRACT

In various embodiment of the present invention, the difference of disparity between subtitles in stereoscopic content along time is restrained by a function of time and disparity. This guarantees that two consecutive subtitles will have similar disparity if they are close in time. More specifically, a method for the positioning of subtitles in stereoscopic content includes estimating a position for a subtitle in at least one frame of the stereoscopic content and restraining a difference in disparity between subtitles in at least two frames by a function of time and disparity. In such an embodiment, the estimating can include computing a disparity value for the subtitle using a disparity of an object in a region in the at least one frame in which the subtitle is to be inserted. The subtitle can then be adjusted to be in front of or behind the object.

### CROSS-REFERENCE TO RELATED APPLICATIONS

This application claims the benefit of U.S. Provisional Application Ser. No. 61/308,174 filed Feb. 25, 2010, and is hereby incorporated by reference in its entirety for all purposes.

### FIELD OF THE INVENTION

The present invention generally relates to subtitles and, more particularly, to a method, apparatus and system for determining disparity estimation for stereoscopic subtitles.

### BACKGROUND OF THE INVENTION

On two-dimensional content, subtitles are usually placed in the same location, for example, at the bottom of a frame or sequence of frames. In contrast, for three-dimensional content, it makes sense to place the subtitles in a particular area of a frame or sequence of frames depending on the elements in the frame(s).

Another factor to consider for three-dimensional content is the disparity involved with displaying three-dimensional content. More specifically, while in two-dimensional content both eyes receive the same frame, for three-dimensional content each eye receives a different frame. As such, the subtitles for three-dimensional content can be rendered in different positions on the horizontal axis. The difference of horizontal positions is called disparity. Disparity of three-dimensional images can cause problems in placing subtitles within three-dimensional content. More specifically, not applying enough disparity or providing too much disparity to a subtitle in a stereoscopic image can negatively affect the image.

For example, FIG. 1 illustrates a problem of subtitles being embedded inside objects of a scene without providing enough disparity to the subtitles. In FIG. 1, on the left part of the figure there are the left and right views of a stereo image with a rendered subtitle. Due to the disparity, the house will pop out of the screen, while the subtitle (with no disparity) will remain in the plane of the screen. The right part of the figure shows the 3D representation of the views and exposes the problem: the house is supposed to cover the subtitle, but the subtitle can be seen inside it.

In addition, FIG. 2 depicts a representative diagram of a subtitle which is improperly embedded in a stereoscopic image, the subtitle having too much disparity compared with an object in the stereoscopic image. In FIG. 2, on the left part of the figure there are the left and right views of a stereo image with a rendered subtitle. Due to its disparity, the house will pop into the screen, while the subtitle will pop out of it. The right part of the figure shows the 3D representation of the views and exposes the problem: the disparity between the house and the subtitle is too high, making the user focus constantly to see both elements.

As such, because there are many more variables that have to be controlled and taken into account, providing subtitles for three-dimensional content is much more complicated than for two-dimensional content.

### SUMMARY OF THE INVENTION

Embodiments of the present invention address the deficiencies of the prior art by providing a method, apparatus and system for disparity estimation for determining a position of a subtitle for stereoscopic content. In various embodiments of the present invention, an algorithm is provided to estimate the disparity of subtitles for stereo sequences.

In one embodiment of the present invention, the difference of disparity between subtitles along time is constrained by a function of time and disparity. This guarantees that two consecutive subtitles will have similar disparity if they are close in time.

More specifically, in one embodiment of the present invention, a method for the positioning of subtitles in stereoscopic content includes estimating a position for a subtitle in at least one frame of the stereoscopic content and constraining a difference in disparity between subtitles in at least two frames by a function of time and disparity. In such an embodiment, the estimating can include computing a disparity value for the subtitle using a disparity of an object in a region in the at least one frame in which the subtitle is to be inserted. The subtitle can then be adjusted to be in front of or behind the object.

In an alternate embodiment of the present invention, a subtitling device for determining a position of subtitles in stereoscopic content includes a memory for storing at least program routines, content and data files and a processor for executing the program routines. In such an embodiment, the processor, when executing the program routines, is configured to estimate a position for a subtitle in at least one frame of the stereoscopic content and constrain a difference in disparity between subtitles in at least two frames by a function of time and disparity.

In an alternate embodiment of the present invention, a system for determining a position of subtitles for stereoscopic content includes a source of at least one left-eye view frame of stereoscopic content in which a subtitle is to be inserted, a source of at least one right-eye view frame of stereoscopic content in which a subtitle is to be inserted and a subtitling device for estimating a position for a subtitle in at least one frame of the stereoscopic content, constraining a difference in disparity between subtitles in at least two frames by a function of time and disparity and inserting the subtitle in the frames using the estimated and constrained position.

### BRIEF DESCRIPTION OF THE DRAWINGS

The teachings of the present invention can be readily understood by considering the following detailed description in conjunction with the accompanying drawings, in which:

FIG. 1 depicts a representative diagram of a subtitle which is improperly embedded in a stereoscopic image, the subtitle lacking sufficient disparity compared with an object in the stereoscopic image;

FIG. 2 depicts a representative diagram of a subtitle which is improperly embedded in a stereoscopic image, the subtitle having too much disparity compared with an object in the stereoscopic image;

FIG. 3 depicts a representative diagram of a rough estimation of a location of subtitles in a stereoscopic image in accordance with an embodiment of the present invention;

FIG. 4 depicts an algorithm to estimate the disparity of a cell in accordance with an embodiment of the present invention;

FIG. 5 depicts a plot of disparity values assigned to the cells along time for the sequence of a movie in accordance with an embodiment of the present invention;

FIG. 6 depicts detail of FIG. 5 after the balancing process of the present invention;

FIG. 7 depicts a plot of disparity values of the movie of FIG. 5 after slicing the subtitling cells into one-frame-long cells in accordance with an embodiment of the present invention;

FIG. 8 depicts a detailed view of the movie of FIG. 5 after applying the inventive concepts of an embodiment of the present invention;

FIG. 9 depicts an example of the treatment of subtitles as objects of an image in accordance with an embodiment of the present invention;

FIG. 10 depicts a high level block diagram of a system for providing disparity estimation for providing subtitles for stereoscopic content in accordance with an embodiment of the present invention;

FIG. 11 depicts a high level block diagram of an embodiment of a subtitle device suitable for executing the inventive methods and processes of the various embodiments of the present invention;

FIG. 12 depicts a high level diagram of a graphical user interface suitable for use in the subtitle device of FIG. 10 and FIG. 11 in accordance with an embodiment of the present invention; and

FIG. 13 depicts a flow diagram of a method for providing disparity estimation for providing subtitles for stereoscopic content in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for providing subtitles and disparity estimations for stereoscopic content. Although the present invention will be described primarily within the context of providing subtitles for three-dimensional content, the specific embodiments of the present invention should not be treated as limiting the scope of the invention. It will be appreciated by those skilled in the art and informed by the teachings of the present invention that the concepts of the present invention can be applied to substantially any stereoscopic image content.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

As previously mentioned, adding subtitles to stereoscopic content, such as three-dimensional (3D) content is much more complicated than adding subtitles to two-dimensional content. For example, for 3D content, it makes sense to place the subtitles in a particular area of a frame or sequence of frames depending on the elements in the frame(s). In addition, for 3D content, the disparity involved with displaying the 3D content has to be taken into account. As such, the subtitles for three-dimensional content can be rendered in different positions on the horizontal axis.

A previously proposed solution is to put the subtitles as close as possible to the objects of the scene, but this can yield to problems too. There are no guarantees that consecutive subtitles close to each other in time will have a similar disparity. A considerable difference of disparity between subtitles close in time can create visual fatigue to the user and ruin the visual experience. More specifically, the disparity of an object present in left and right frames of a stereo sequence can be zero, positive or negative. When the disparity is zero, the 3D projection of the object will be in the plane of the screen. When the disparity is positive, the object will pop into the screen, and when it is negative, the object will pop out of the screen. Typically, the disparity is measured in pixels.

There are several methods to estimate the disparity of the objects of the scene. A possible classification of the methods is by the number of disparity points that they provide. Therefore, two categories are:

Dense disparity maps, where each pixel (or almost each pixel) has a disparity value.
Sparse disparity maps, where only a few pixels have a disparity value.
The implementation and description of the methods of the various embodiments of the present invention described herein implement a sparse disparity map, but a dense disparity map can also be used in accordance with the concepts of the present invention without affecting the procedure or the results.

In describing the concepts of the present invention, the inventors define subtitles as being divided in units that are defined as cells. Each cell is typically composed of an incremental unique identifier, a timestamp and the text itself.

In one embodiment of the present invention, the fields in a subtitle cell are:
Timestamp, which dictates when the subtitle has to be rendered.
Text, which is the subtitle text to be rendered.
In accordance with an embodiment of the present invention, the location of subtitles for a stereoscopic image begins with an estimation. That is, the region in which the subtitles are going to be rendered can be estimated before rendering. Even if the exact dimensions or placement of the region is not completely known (the size and font of the subtitles can vary, so can the region) a rough estimate is enough to begin. For example, FIG. 3 depicts a representative diagram of a rough estimation of a location of subtitles in a stereoscopic image in accordance with an embodiment of the present invention. As depicted in the embodiment of FIG. 3, the subtitles are located in front of and close to the objects behind them. As such, the disparity value for the subtitles is computed using the disparity of the objects in the subtitle region.

In one embodiment of the present invention, the size and placement of the subtitle region is defined on percentage of the frame size, being the X-range from 10% to 90% of the frame width and the Y-range from 70% to 100% of the frame height.

In accordance with various embodiments of the present invention, the disparity of a subtitle cell is estimated according to the following relations:

C={c₁, c₂, . . . , c_{M}} depicts the set of subtitle cells and tᵢ the timestamp of the subtitle cell cᵢ (note that the timestamp tᵢ indicates in which frames the text of the subtitle cell cᵢ has to be rendered). F^{t}^{ᵢ}={f₁^{t}^{ᵢ}, f₂^{t}^{ᵢ}, . . . , f_{N}^{t}^{ᵢ}} depicts the set of frames covered by the timestamp tᵢ and D_{R} depicts the set of disparities D inside the subtitles region R. D_{R}^{t}^{ᵢ} depicts the set of disparities inside the region R covered by the timestamp tᵢ and

$${D}_{R}^{{{f}_{j}}^{{t}_{i}}}$$

depicts the set of disparities D (sorted in increasing order) inside the region R of the j^{t}^{ᵢ} frame in F^{t}^{ᵢ}.

The relations described above assign a disparity value \hat{d}ᵢ to the subtitle cell cᵢ. For this purpose the set of disparity values D_{R}^{t}^{ᵢ} is used. In accordance with the present invention, \hat{d}ᵢ is set to the minimum disparity value of D_{R}^{t}^{ᵢ}+α, where α is a negative value (bear in mind that the lower the disparity, the closer to the user is the 3D projection of the object, and the subtitles have to be closer than any other object in R during tᵢ).

It should be noted that some of the disparities in D_{R}^{t}^{ᵢ} can be outliers. Consequently, the means to estimate d, has to be able to handle such inconveniences. One way of resolving the issue of outliers is illustrated in FIG. 4. More specifically, FIG. 4 depicts an algorithm to estimate the disparity \hat{d}ᵢ of a cell cᵢ. In FIG. 4, D_{d} depicts the default disparity for a subtitle cell and D_{N} depicts a maximum disparity value.

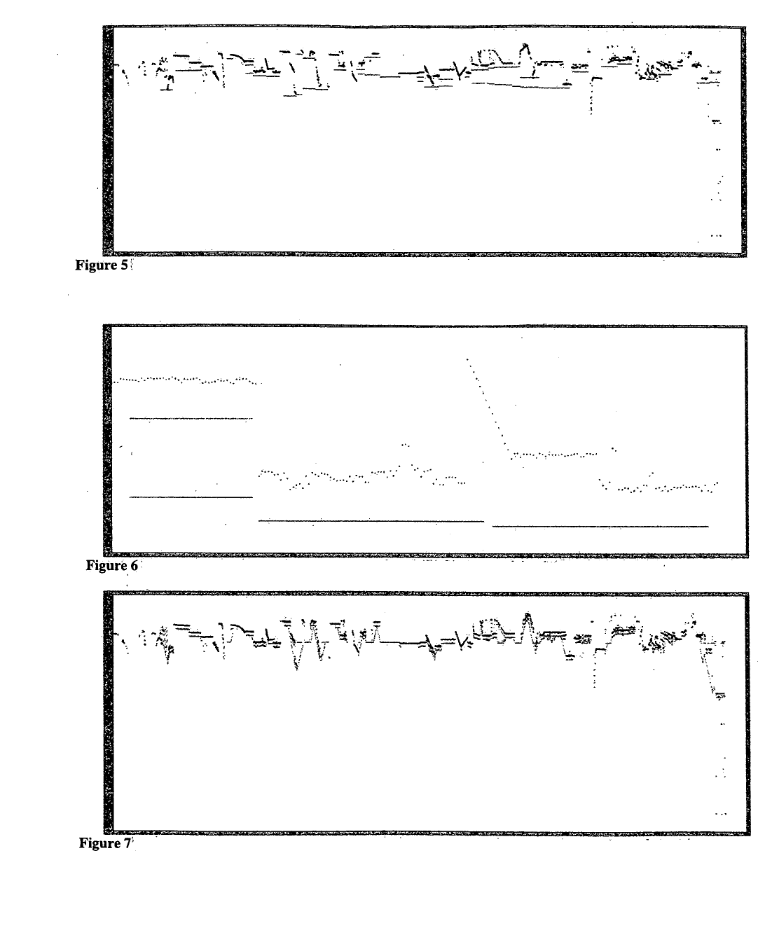

For example, FIG. 5 depicts a plot of disparity values assigned to the cells along time for the sequence of a movie in accordance with an embodiment of the present invention. The red dots represent the estimated disparity in D_{R} for all the frames. The thick yellow lines are the disparity values assigned to the subtitle cells before the balancing process. The thin blue lines are the disparity values assigned to subtitle cells after the balancing process.

In one embodiment of the present invention, the disparity values are computed using the horizontal component of the displacement vector between two feature points. In addition, the variables of the algorithm explained in FIG. 4 are: D_{d}=−10, D_{M}=−80, V=10, W=10, P=6, Q=6 and α=−5.

In accordance with the present invention, a disparity value \hat{d}ᵢ is assigned to each subtitle cell cᵢ as described above. The values of the embodiment of FIG. 4 have been assigned without knowledge of their neighbors, which can lead to bothersome jumps of disparity between two consecutive cells.

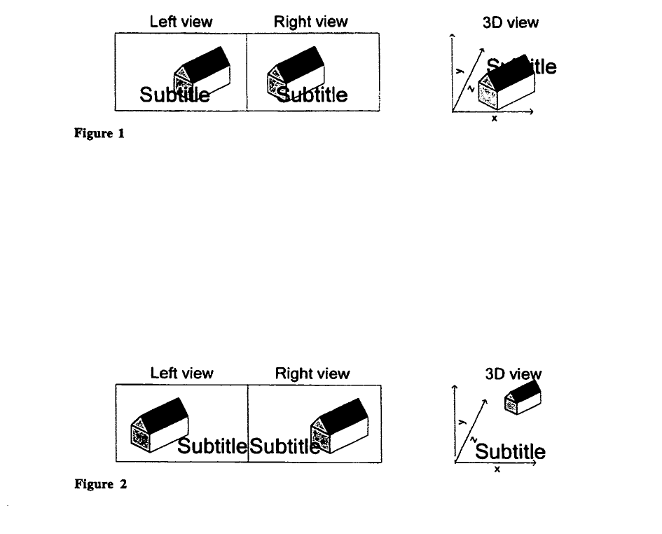

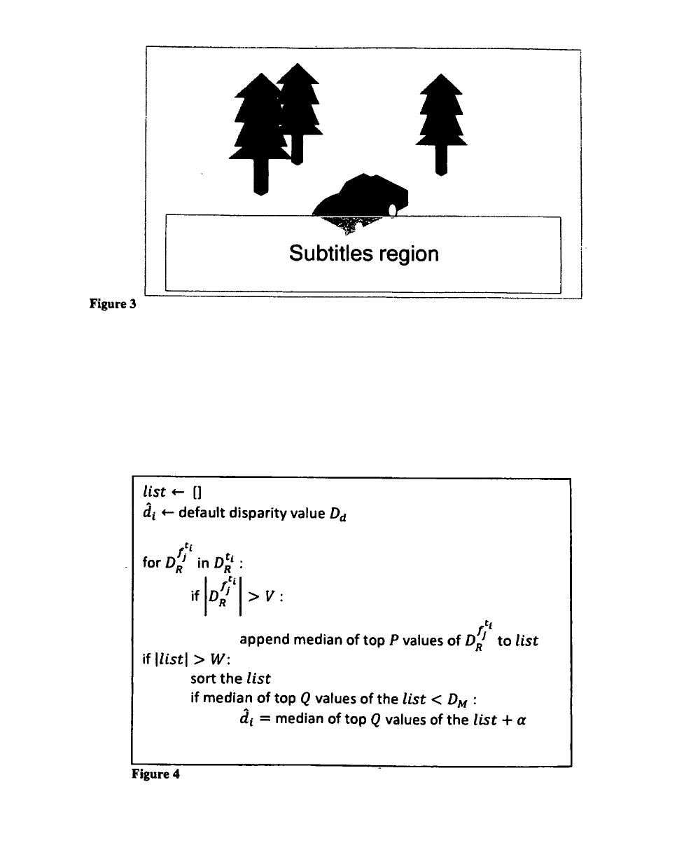

In accordance with an embodiment of the present invention, in order to fix this problem, the subtitle cells have to be balanced. This consists in introducing a constraint, function of time and disparity, to the set of disparities of C. In one embodiment of the present invention, the subtitles close in time (i.e., number of frames) are forced to have a similar disparity. In one embodiment of the present invention, this is accomplished by adding a negative value to the subtitle cell with higher disparity (i.e., 3D projection closer to the screen) in order to avoid the problem depicted in FIG. 1.

For example, FIG. 6 depicts detail of FIG. 5 after the balancing process of the present invention as described above. Notice that in FIG. 6, the disparity assigned to two of the three cells remains the same after the balancing process, while the other one changes.

In one embodiment of the present invention, an algorithm for adding a negative value to the subtle cell with higher disparity follows:

```
convergence ← true
do:
    for i in 1 . . . (|C| − 1):
      $if \begin{matrix}\vert {\hat{d}}_{i} - {\hat{d}}_{i + 1} \vert \\ gap ( {t}_{i} , {t}_{i + 1} )\end{matrix} > T \text{:}$
        if \hat{d}ᵢ < \hat{d}ᵢ₊₁:
          \hat{d}ₜ₊₁ ← \hat{d}ₜ₊₁ + ε
        else:
          \hat{d}ᵢ ← \hat{d}ᵢ + ε
        convergence ← false
while convergence = false
```

where gap(tᵢ,tᵢ₊₁) is the number of frames between the end of the timestamp tᵢ and the beginning of the timestamp tᵢ₊₁, T is a threshold and ε is a negative value. In one embodiment T=3 and ε=1.

In various embodiments of the present invention, subtitle cells of C can be sliced in one-frame-long cells, generating a new set of cells. The result of applying the disparity estimation method of the present invention to this new set of subtitle cells leads to subtitles that smoothly move on the Z axis according to the disparity of the elements on D_{R}. This technique leads to a better user experience. Although in the described embodiment, one-frame-long cells have been generated, in alternate embodiments of the present invention, it is also possible to generate cells of a larger number of frames. In addition, the disparity values can be filtered again to constrain even more temporal consistency.

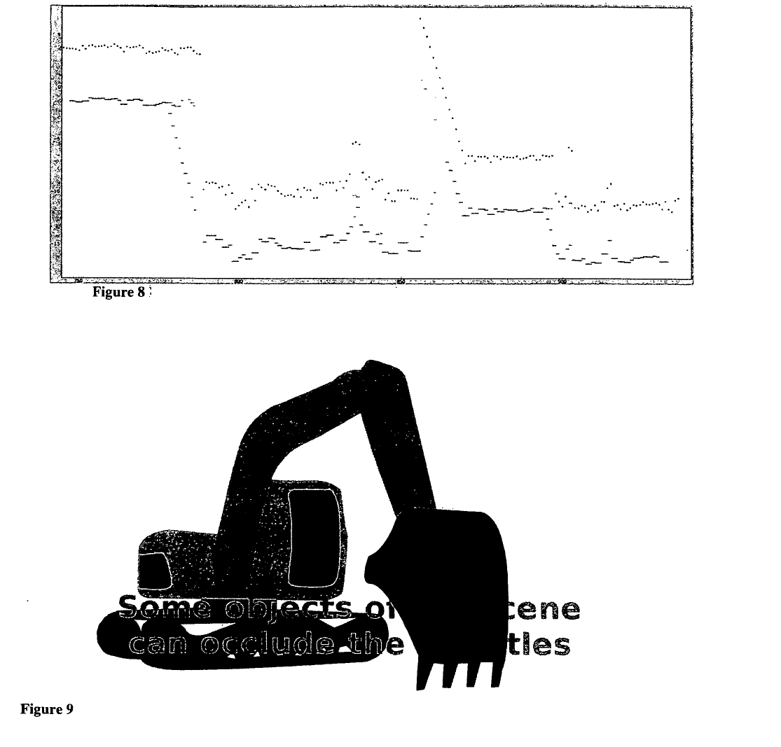

For example, FIG. 7 depicts a plot of disparity values of the movie of FIG. 5 after slicing the subtitling cells into one-frame-long cells in accordance with an embodiment of the present invention. Even further, FIG. 8 depicts a detailed view of the movie of FIG. 5 after applying the inventive concepts of an embodiment of the present invention. Notice how the disparity changes smoothly along time.

In accordance with the concepts of the present invention, subtitles can be treated as other objects of the scene. That is, subtitles can be occluded partially or totally by objects present in the content. For example, FIG. 9 depicts an example of the treatment of subtitles as objects of an image in accordance with an embodiment of the present invention. In FIG. 9 a digger and text are used as examples of objects of a scene. Let's imagine that the disparity of the shovel is −50 and the disparity of the chains on the tracks is −10. The subtitles can be integrated into the scene by rendering them in a disparity value between the shovel and the chains (i.e. −30). Moreover, only the part of the subtitles not overlapping with the shovel will be rendered. The text of the subtitles in FIG. 9 is “Some objects of the scene can occlude the subtitles”.

In addition, in accordance with the concepts of the present invention besides disparity, other features of the subtitles (like size, color, texture, font . . . ) can also change depending on the characteristics of the scene. For example, the size of a subtitle can increase when it pops out of the screen. In addition, the algorithm of the present invention can be improved to balance the subtitles in a faster way. For example, in one embodiment of the present invention, a maximum disparity value can be set such that when a difference of disparity between two subtitle cells is higher than the maximum allowed, the disparity of the cell that has to change can be set to the disparity of the other cell plus the maximum difference of disparity allowed between them.

Even further, in alternate embodiments of the present invention, regions of interest are determined and the subtitles are placed at the same disparity of the objects there. If there are objects with more negative disparity in the subtitles region, the disparity will be set to the one there. Subtitles can be balanced too.

Furthermore, in accordance with various embodiments of the present invention, a default disparity value can be set. As such, subtitle cells with the default disparity value can be disregarded as anchor points to pull other subtitle cells to its position. In addition, the disparity values can be computed using the horizontal component of the displacement vector between two feature points, but both horizontal and vertical components can be used to compute the disparity values. In such an embodiment, the region D_{R} can change with time.

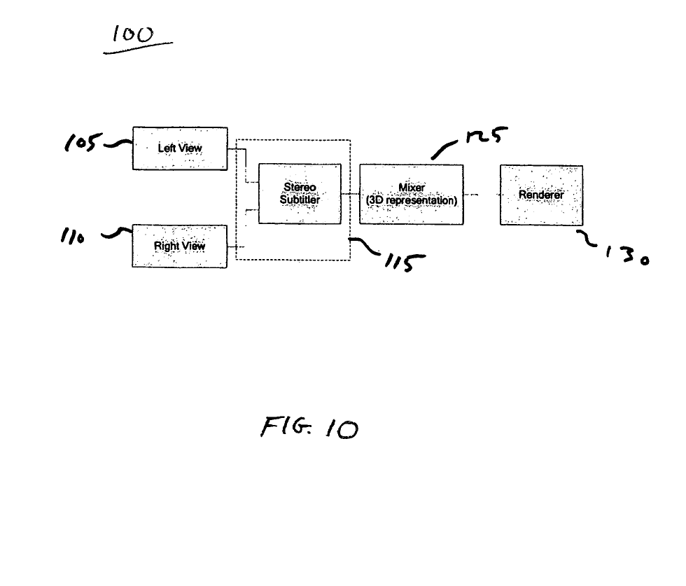

FIG. 10 depicts a high level block diagram of a system 100 for providing disparity estimation for providing subtitles for stereoscopic (3D) content in accordance with an embodiment of the present invention. The system 100 of FIG. 10 illustratively includes a source of a left-eye view 105 and a source of a right-eye view 110 of the 3D content. The system 100 of FIG. 10 further includes a stereo subtitle device 115, a mixer 125 and a renderer 130 for rendering stereoscopic (3D) images.

In the system 100 of FIG. 10, content from the left-eye view source 105 and the right-eye view source 110 are communicated through the stereo subtitle device 115 to the mixer 125. In one embodiment of the present invention, the mixer 125 of the system 100 of FIG. 10 is capable of mixing the content from two sources 105, 110 using a mode supported on a 3D display, for example, a line interleaved or checkerboard pattern. The stereo subtitle device 115 receives the content from the left-eye view source 105 and the right-eye view source 110 and information (e.g., a text file) containing information regarding the subtitles to be inserted into the stereoscopic (3D) images. That is, in one embodiment of the present invention, the stereo subtitle device 115 receives stereoscopic images and information regarding a subtitle in the received stereoscopic images in which a subtitle(s) is to be inserted. The subtitle device of the present invention, estimates a position for a subtitle in at least one frame of the three-dimensional content and constraining a difference in disparity between subtitles of subsequent frames by a function of time and disparity in accordance with the concepts of the present invention and specifically as described above.

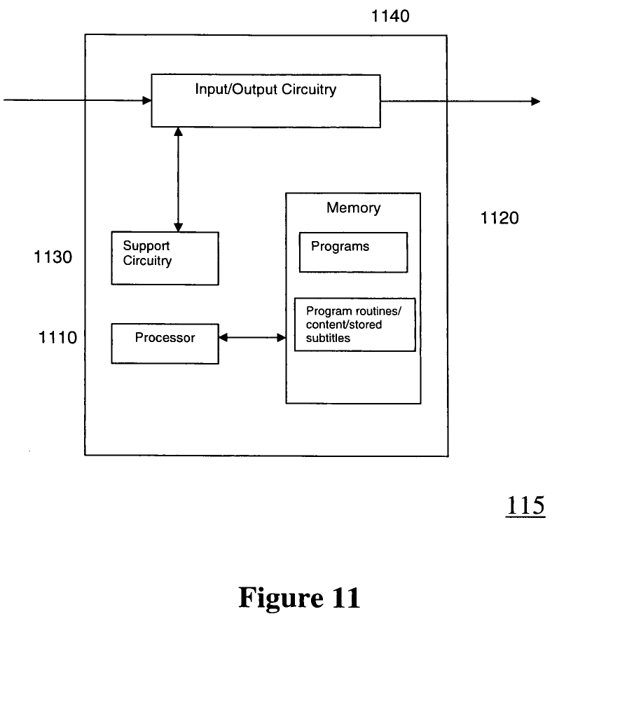

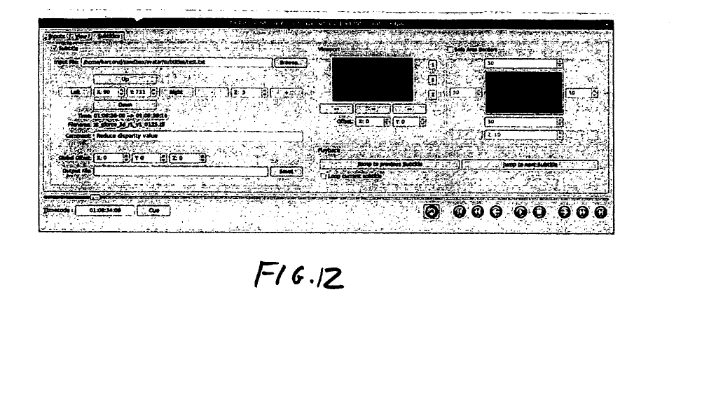

FIG. 11 depicts a high level block diagram of an embodiment of a subtitle device 115 suitable for executing the inventive methods and processes of the various embodiments of the present invention. More specifically, the subtitle device 115 of FIG. 11 illustratively comprises a processor 1110 as well as a memory 1120 for storing control programs, file information, stored media and the like. The subtitling device 115 cooperates with conventional support circuitry 1130 such as power supplies, clock circuits, cache memory and the like as well as circuits that assist in executing the software routines stored in the memory 1120. As such, it is contemplated that some of the process steps discussed herein as software processes may be implemented within hardware, for example, as circuitry that cooperates with the subtitling device 115 to perform various steps. The subtitle device 115 also contains input-output circuitry 1140 that forms an interface between various functional elements communicating with the subtitle device 115 such as mixers, displays, content sources and the like.

Again, although the subtitle device 115 of FIG. 11 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

FIG. 12 depicts a high level diagram of a graphical user interface suitable for use in the subtitle device of FIG. 10 and FIG. 11 in accordance with an embodiment of the present invention. As depicted in FIG. 12, a GUI in accordance with an embodiment of the present invention can include a browser to locate a file to load, left and right position indicators for a subtitle, up and down buttons to offset the left and right positions, a global offset indicator and x, y, z adjustment buttons, a text bar for naming an output file, a time and filename indicator, and a timecode indicator and cue button. In accordance with an embodiment of the present invention, the z adjustment is used to adjust the disparity or position of a subtitle in a frame and is used to perform the described inventive concepts of the present invention for positioning subtitles as described above.

The GUI of FIG. 12 further illustratively includes a playback viewport including play/pause, forward and reverse buttons. The viewport area of the GUI of FIG. 12 further includes x and y fine tuning offset buttons and indicators. The playback of a subject subtitle can be configured to playback in a loop or a previous or subsequent subtitle can be selected using respective buttons. As depicted in FIG. 12, in another area of the GUI of FIG. 12, a user can optionally configure safe area borders for a subtitle. More specifically, in one embodiment of the present invention, a safe subtitle area can be configured on the frames of stereoscopic content. When such an area is designated by, for example, using the GUI of FIG. 12, only elements inside that area are guaranteed to be rendered on any compliant display.

As depicted in FIG. 12, a GUI of the present invention can further include a comments section for inserting comments for subtitles. In one embodiment of the present invention, the comments are displayed on the GUI and are stored with the controller file information.

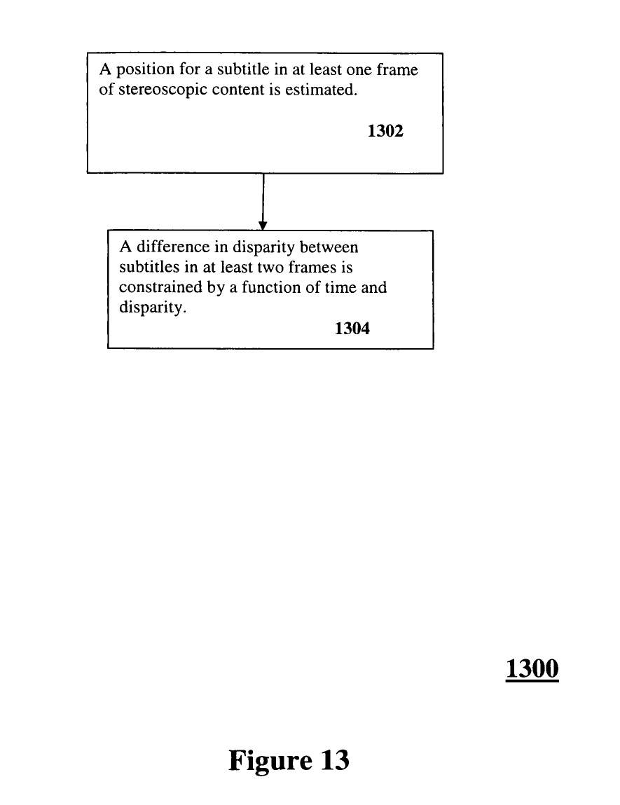

FIG. 13 depicts a flow diagram of a method for providing disparity estimation for providing subtitles for stereoscopic content in accordance with an embodiment of the present invention. The method 1300 of FIG. 13 begins at step 1302 during which a position for a subtitle in at least one frame of stereoscopic content is estimated. As described above, in one embodiment of the present invention, the estimating includes computing a disparity value for the subtitle using a disparity value of an object in a region in the at least one frame in which the subtitle is to be inserted. The method 1300 proceeds to step 1304.

At step 1304, a difference in disparity between subtitles in at least two frames is constrained by a function of time and disparity. As described above, in one embodiment of the present invention, a difference in disparity between subtitles in the at least two frames is constrained by applying a negative disparity value to a subtitle having a higher disparity value. That is, in various embodiment of the present invention, a maximum difference of disparity in subtitles between frames is set such that when a difference of disparity between two subtitles is higher than the maximum, the disparity value of the subtitle that has to change is set to the disparity value of the other subtitle plus the maximum difference of disparity. The method 1300 is then exited.

Having described various embodiments for a method, apparatus and system for disparity estimation for providing subtitles for stereoscopic content (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for determining a position of subtitles in stereoscopic content, comprising:
estimating a position for a subtitle in at least one frame of said stereoscopic content; and
constraining a difference in disparity between subtitles in at least two frames by a function of time and disparity.

2. The method of claim 1, wherein said estimating comprises computing a disparity value for the subtitle using a disparity of an object in a region in said at least one frame in which the subtitle is to be inserted.

3. The method of claim 2, wherein said subtitle is positioned in front of and close to the object.

4. The method of claim 2, wherein the region comprises a subtitle region and a size and placement of the subtitle region is defined on a percentage of a size of said at least one frame.

5. The method of claim 1, wherein a difference in disparity between subtitles in the at least two frames is constrained by applying a negative disparity value to a subtitle having a higher disparity value.

6. The method of claim 1, further comprising setting a maximum difference of disparity such that when a difference of disparity between two subtitles is higher than the maximum, the disparity value of the subtitle that has to change is set to the disparity value of the other subtitle plus the maximum difference of disparity.

7. The method of claim 1, further comprising dividing subtitles into cells.

8. The method of claim 1, further comprising setting a default disparity value such that a subtitle with the default disparity value is regarded as an anchor point to pull other subtitles to its position.

9. The method of claim 1, wherein said constraining is performed using an algorithm.

10. A subtitling device for determining a position of subtitles in stereoscopic content, comprising:
a memory for storing at least program routines, content and data files; and
a processor for executing said program routines, said processor, when executing said program routines, configured to perform the steps of:
estimating a position for a subtitle in at least one frame of said stereoscopic content; and
constraining a difference in disparity between subtitles in at least two frames by a function of time and disparity.

11. The subtitling device of claim 10, wherein said subtitling device comprises a graphical user interface for enabling a user to position a subtitle in at least one frame of said stereoscopic content.

12. A system for determining a position of subtitles for stereoscopic content, comprising:
a source of at least one left-eye view frame of said stereoscopic content in which a subtitle is to be inserted;
a source of at least one right-eye view frame of said stereoscopic content in which a subtitle is to be inserted; and
a subtitling device for:
estimating a position for a subtitle in at least one frame of said stereoscopic content;
constraining a difference in disparity between subtitles in at least two frames by a function of time and disparity; and
inserting the subtitle in said frames using said estimated and constrained position.

13. The system of claim 12, further comprising a mixer for mixing a subtitled at least one left-eye view frame with a corresponding subtitled at least one right-eye view frame.

14. The system of claim 12, further comprising a rendering device for rendering said subtitled, stereoscopic content.

15. The system of claim 12, further comprising a user interface for enabling a user to position a subtitle in at least one frame of said stereoscopic content.
